(19) United States
(12) Patent Application Publication
(10) Pub. No.: US 2019/0184421 A1
(43) Pub. Date: Jun. 20, 2019

(54) Phillips Smart Edge

(71) Applicant: Howard Marcellus Phillips, Los Angeles, CA (US)

(72) Inventor: Howard Marcellus Phillips, Los Angeles, CA (US)

(73) Assignee: Howard Marcellus Phillips, Los Angeles, CA (US)

(21) Appl. No.: 15/531,470

(22) PCT Filed: May 27, 2017
(86) PCT No.: PCT/US17/30289

§ 371 Date: May 30, 2017

(51) Int. Cl. B05C 17/02

(52) U.S. Cl. CPC B05C 17/0212; B05C 17/0215

(57) ABSTRACT

The Phillips Smart Edge is a paint application tool with guide means, made of synthetic material and is used for painting in any standard rooms corner in edgeing and trimming. The cornered walls intersecting surface characterized in that the guide means in the form of a roller project outward and parallel (FIG. 2) Metal Bars as they lead downward. Preferably the applicating surface is triangleular as standard walls with the roller overhanging edges which converge toward each other. The paint is applied to surface rapidly and efficiently in use for the Phillips Smart Edge.

### Detailed Description of the Invention

The Phillips Smart Edge is a Paint Application Tool made of synthetic material and is used for painting in any standard cornered wall or area, in edging or trim work in any room's corner. The paint is applied to surface rapidly and efficiently. It alleviates having to use two apparatuses, its new and its idea is to save time. The Phillips Smart Edge consists of (FIG. 1) Roller at ⅜ in and at 7 in. in length and arched in the middle to place paint in any cornered wall or surface absorbs paint and transfers it to surface. (FIG. 2)

Metal Bars that lead 2 in downward and at the top of 2 in Metal Bars ¼ in. of each side tilts inward to roller on both sides (that connects) and then at bottom of (FIG. 2) Metal Bars at 2 in lead inward (lateral) at 7½ that meet in the middle and then lead downward at 5 in. into (FIG. 3) the bottom plastic handle. (FIG. 3) Plastic Handle 6 in. in length for gripping with either hand to apply paint. Parts of “roller frame” (a) one part metal and (b) one part plastic. “And a roller cover” (synthetic). The roller cover absorbs the paint and transfers it to the surface the roller frame (FIG. 2)&(FIG. 3) attaches to the roller cover and can be held with either hand in use. The roller (FIG. 1) is synthetic and manufactured the instructional use is very easy and anyone that has pertinent skills in the Background of the Invention will be able to use the Phillips Smart Edge with ease. Using is the Phillips Smart Edge with ease, its very comparable to anyone who knows of specifics in the Technical Field of the paint application tool. By placing the roller (FIG. 1) between the metal bars (FIG. 2) part of the entire handle (FIG. 2) (FIG. 3) Plastic Handle it fits and is in place to hold, and has a feel that theres a connected piece as it combines with metal bars (FIG. 2) and to place onto the other side of metal bars (FIG. 2) repeat steps in placing roller (FIG. 1) on other side of metal bars (FIG. 2) and in between as it fits and stays in place to hold for use. The Plastic Handle (FIG. 3) is for gripping with either hand as you use rapid and efficient motions in any cornered wall or surface as tray (with tray being filled with paint of course) and roll roller (FIG. 1) several times back and forth in smooth motion to santurate roller (FIG. 1) and lift and apply paint to any cornered wall or surface, for continued use of the Phillips Smart Edge, repeat steps. The Phillips Smart Edge is only to be used in the edging or trim work of painting. The word “Industry” is a corresponding word that goes with the Technical Field in my invention (“Construction Industry”) and is meant to be explodable in the Technical Field (“Construction Industry”) Sub-Field “Painting” and the correspondence with the two words “ Construction” and “Industry” have full meaning in which my invention pertains in the Technical Field. The non-complexity of the Phillips Smart Edge is revelating, the standard it brings as its new and what tasks are completed with a perfection.

### Brief Summary of the Invention

The Phillips Smart Edge is a painting application tool. A handle (FIG. 3) secured to another part metal bars (see FIG. 2) that are connected to roller (FIG. 1). The roller is arched and in position to be applied to any paint and thus being placed on an area of any cornered wall or surface for areas consumption. This invention is directed, in brief, to the general purpose painting tool. The best mode currently contemplated by me for carrying out the invention includes which is used for painting any cornered wall or surface. A great advantage for its use is that it alleviates using two apparatuses during edgeing or trimming a wall. The idea is to be able to hold one apparatus in one hand while completing a specific (edgeing) task.

### Description of the Preferred Embodiment

The applicator of this invention includes a handle. The applicator of this invention (FIG. 1) is connected to (FIG. 2) Metal Bars and then connected to a handle (FIG. 3). The applicator itself is arched in the middle and made of synthetic material. The embodiment of the applicator enables a user to have pronunciation in there work because of the divisional characteristics of the invention in the arch that's in the middle that set it aside from others in the before. Applicator is arched in the middle, it leads downward at angle on each side that measures the same distance as metal bars (FIG. 2). Metal Bars (FIG. 2) lead downward and then inward (lateral) and then downward again at different measurements and are one part of two for overall handle (FIG. 2) & (FIG. 3). (FIG. 3) Plastic Handle that makes up one part of two parts with metal bars (FIG. 2). for overall (both parts) Handle (FIG. 2) & (FIG. 3). In use when the applicator is used to apply paint it will make an adjustsment by a moving part the roller. The roller having already being measured for any standard wall or surface and having no contrast in the way.

### Brief Description of the Prior Art

When painting surfaces which intersect where several surfaces are to be painted. Its desirable to utilize an, application tool to cover several surfaces with paint. The painting applicator has a roller that is arched in the middle to reach cornered walls and apply paint thoroughly.

Pertinent prior art patents which show instruments are the patents to Frederick B. Burns U.S. Pat. No. 3,605,165 A: Gregg Moore Charles U.S. Pat. No. 3,359,589 A: Frederick Wood Jr. U.S. Pat. No. 2,810,148 A. The applicator shown in Burns U.S. Pat. No. 3,605,165 A is a paint applicator with guide means for painting a surface which abuts an intersecting surface, characterized in that the guide means, preferably in the form of rollers, project outwardly beyond opposite sides of the applicator and lie on either side of the handle. Preferably, the applicating surface is trapezoidal with the rollers overhanging nonparallel edges which converge toward each other. The applicator shown in Charles U.S. Pat. No. 3,359,589 A This invention relates generally, as indicated, to a painting device and, more particularly, to a device which is adapted to apply paint uniformly to a surface in a straight line adjacent an edge formed as by the intersection of two walls or a wall and a ceiling or floor, such device having particular utility in applying paint to a corner area formed as by the intersection of two walls and the ceiling or floor. The applicator shown in Wood U.S. Pat. No. 2,810,148 A: the paint applicator shown comprises a carriage in the form of a flat rectangular frame plate from the rear side of which a handle 11 extends outwardly. The handle 11 is preferably of rectangular shape and is arranged centrally and toward the bottom of the plate 10 as shown. In use the operator of the device would grasp the opposite vertical sides of the handle 11 between his fingers. These vertical sides may be serrated if desired to provide a better hold. All of these prior art devices are suitable for and intended only for use in trim work and not for general paint application. Thus a user might switch between applicators for general application and another applicator for trim work.

### BACKGROUND OF THE INVENTION

This Phillips Smart Edge invention relates to paint application tools and more particularly to an improved guide for means thereof.

Brief Description of the Prior Art when painting surfaces which intersect where several surfaces are to be painted. Its desirable to utilize an application tool to cover several surfaces with paint. The painting applicator has a roller that is arched in the middle to reach cornered walls and apply paint thoroughly Pertinent prior art patents which show instruments are the patents to Frederick B. Burns U.S. Pat. No. 3,605,165 A: Gregg Moore Charles U.S. Pat. No. 3,359,589 A: Frederick Wood Jr. U.S. Pat. No. 2,810,148 A

The applicator shown in Burns U.S. Pat. No. 3,605,165 A is a paint applicator with guide means for painting a surface which abuts an intersecting surface, characterized in that the guide means, preferably in the form of rollers, project outwardly beyond opposite sides of the lapplicator and lie on either side of the handle. Preferably, the appealing surface is trapezoidal with the rollers overhanging nonparallel edges which converge toward each other.

The applicator shown in Charles U.S. Pat. No. 3,359,589 A. This invention relates generally, as indicated to a painting device and, more particularly, to a device which is adapted to apply paint uniformly to a surface in a straight line adjacent an edge formed as by the intersection of two walls or a wall and a ceiling or floor, such device having particular utility in applying paint to a corner area formed as by the intersection of two walls and the ceiling or floor.

The applicator shown in Wood U.S. Pat. No. 2,810,148 A the paint applicator shown comprises a carriage in the form of a fiat rectangular frame plate from die rear side of which a handle 11 extends outwardly. The handle 11 is preferably of rectangular shape and is arranged centrally and toward the bottom of the plate 10 as shown, in use the operator of the device would grasp the opposite vertical sides of the handle 11 between his fingers. These vertical sides may be serrated if desired to provide a better hold.

All of these prior are devices are suitable for and intended only for use in trim work and not for general paint application. Thus a user might switch between applicators for general application and another applicator for trim work.

### BRIEF DESCRIPTION OF VIEW(S) OF THE DRAWING

FIG. 1 is a section view taken generally along the lines of FIG. 1.

FIG. 2 is a section view taken generally along the lines of FIG. 2.

FIG. 3 is a section view taken generally along the lines of FIG. 3.

With this invention being susceptible of embodiment, there is shown in the drawing and will herein be described in detail, a specific embodiment thereof, with the understanding that the present disclosure is to be considered as an exemplication of the principles of the invention and is not intended to limit the invention to the embodiment illustrated

### Specifications

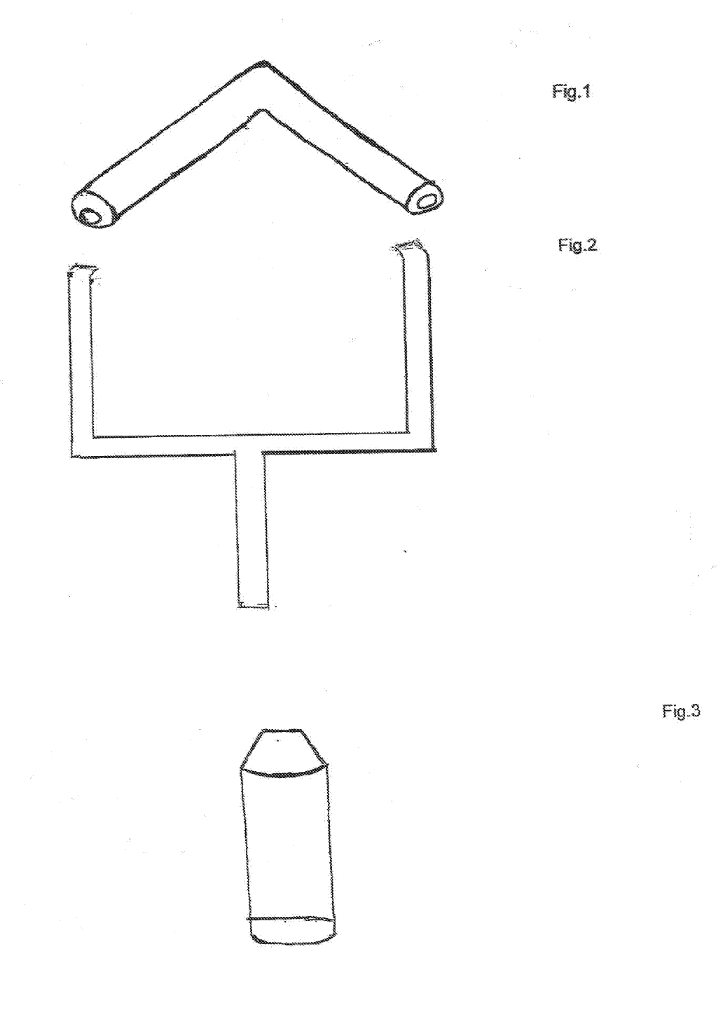

The Phillips Smart Edge in (FIG. 1) is a roller that absorbs paint and transfers it to any cornered wall or surface. Roller is at ⅜ in. in diameter and 7 in. in entire length, arched in the middle and 7 in. in entire length. Metal bars in (FIG. 2) connect on sides of roller for movement of roller against any surface for edgeing and trimming. (FIG. 2) Metal bars at 2 in. and at the top of tin Metal Bars ¼ in of each side tilts inward to roller on each side (that connects) and then downward at bottom of (FIG. 2) Metal Bars at 2 in. at bottom then lead inward (lateral) and meet in the middle and metal bars in that area of (FIG. 2) go across at 7½ in. in entire length, and then lead downward at 5 in. in that area of (FIG. 2) into plastic handle in (FIG. 3). (FIG. 3) Plastic Handle at 6 in. in length that can be held with either hand to apply paint to surface.

### Phillips Smart Edge

### Brief Summary of Specifications

The Phillips Smart Edge in (FIG. 1) is a roller that transfers paint to any cornered wall or surface. Roller is ⅜ in. in Diameter and 7 in. in entire length and arched in the middle. (FIG. 2) Metal Bars in (FIG. 2) connect on sides of rollers for movement. Metal Bars (FIG. 2) are 2 in. and at top of Metal Bars ¼ in. on each side tilts inward to roller and connects Metal Bars (FIG. 2) that lead downward on each side and at bottom of 2 in. Metal Bars (FIG. 2) (FIG. 2) Metal Bars then lead inward (lateral) and meet. Overall length in that area of (FIG. 2) is 7½ in. (FIG. 2) Metal Bars then lead downward at 5 in. into (FIG. 3) Plastic Handle. (FIG. 3) Plastic Handle is 6 in. in length that connect to (FIG. 2) and can be held with either hand for or and in use.

### Specifications, Phillips Smart Edge

(FIG. 1) ⅜ in. in Dm and 7 in. L

(FIG. 2) 2 in. HT×7½ in. Wid×5 in. HT

(FIG. 3) 6 in. L

### Technical Specifications:

The Phillips Smart Edge has a roller at ⅜ in. in diameter and 7 in. in entire length as shown in (FIG. 1), arched in the middle that connect to metal bars, meatal bars as shown in (FIG. 2). Roller is placed in area between metal bars in (FIG. 2) that connect by holding one area on one side of roller and placing it between one area on same side of Metal Bars (FIG. 2) and repeating steps for other side of roller in (FIG. 1)for other side of roller for roller movement. Metal bars as shown in (FIG. 2) at 2 in. and at top of (FIG. 2) Metal Bars ¼ in. on each side tilts inward to roller on each side (that connects) and then lead downward at bottom of (FIG. 2). Metal Bars (FIG. 2) then lead inward (lateral) and meet in the middle at 7½ in. in entire length, and then lead downward at 5 in. into plastic handle as shown in (FIG. 3) at 6 in which is held in either hand and using a rapid and efficient motion to apply paint to surface with either hand holding Plastic Handle in (FIG. 3). (FIG. 3) Plastic Handle in length is at 6 in. and can be held with either hand to apply paint to any cornered wall or surface.

1. What I claim as my invention is the Phillips Smart edge, a painting application tool used for edgeing and trimming in any cornered wall or surface and can be used by anyone with pertinent skills or by anyone.

2. This Phillips Smart Edge invention relates to paint application tools and more particularly to an improved and new guide for means thereof.
